(19) United States
(12) Patent Application Publication
(10) Pub. No.: US 2026/0287334 A1
(43) Pub. Date: Sep. 24, 2026

(54) SYSTEM AND METHOD FOR TRANSPARENT LAYER COMPENSATION IN 3D OPTICAL METROLOGY

(71) Applicant: Orbotech Ltd., Yavne (IL)

(72) Inventors: Elkana Porat, Yavne (IL); Nir Turko, Rehovot (IL)

(21) Appl. No.: 19/567,859

(22) Filed: Mar. 16, 2026

Related U.S. Application Data
(60) Provisional application No. 63/774,115, filed on Mar. 19, 2025.

(51) Int. Cl. G01B 11/24

(52) U.S. Cl. CPC G01B 11/2441

(57) ABSTRACT

An illumination subsystem includes a light source that emits light split into a reference beam and an object beam and a beam steering element that directs the object beam to a workpiece disposed on a stage. A detection subsystem includes a first beam splitter that combines the reference beam with the object beam transmitted through the workpiece or reflected by the workpiece into a combined beam and a detector that generates a detection signal based on the combined beam. A processor receives the detection signal from the detector as the stage scans relative to the object beam for a scan length, the illumination subsystem adjusts an effective illumination wavelength of the object beam for a portion of the scan length in an area of destructive interference, and the processor generates an interference image of the workpiece based on the detection signal received for the entire scan length.

### CROSS-REFERENCE TO RELATED APPLICATIONS

This application claims priority to U.S. App. No. 63/774,115, filed Mar. 19, 2025, the entire disclosure of which is hereby incorporated by reference.

### FIELD OF THE DISCLOSURE

This disclosure relates to semiconductor inspection and metrology systems and, more particularly, to interferometry-based inspection and metrology systems.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it determines the return-on-investment for a semiconductor manufacturer.

Fabricating semiconductor devices, such as logic and memory devices, typically includes processing a semiconductor workpiece (e.g., wafer, substrate, display panel, etc.) using a large number of fabrication processes to form various features and multiple levels of the semiconductor devices. For example, lithography is a semiconductor fabrication process that involves transferring a pattern from a reticle to a photoresist arranged on a semiconductor workpiece. Additional examples of semiconductor fabrication processes include, but are not limited to, chemical-mechanical polishing (CMP), etch, deposition, and ion implantation. Multiple semiconductor devices may be fabricated in an arrangement on a single semiconductor workpiece that are separated into individual semiconductor devices.

Inspection processes are used at various steps during semiconductor manufacturing to detect defects on workpieces to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Metrology processes are also used at various steps during semiconductor manufacturing to monitor and control the process. Metrology processes are different than inspection processes in that, unlike inspection processes in which defects are detected on workpieces, metrology processes are used to measure one or more characteristics of the workpieces that cannot be determined using existing inspection tools. Metrology processes can be used to measure one or more characteristics of workpieces such that the performance of a process can be determined from the one or more characteristics. For example, metrology processes can measure a dimension (e.g., line width, thickness, etc.) of features formed on the workpieces during the process. In addition, if the one or more characteristics of the workpieces are unacceptable (e.g., out of a predetermined range for the characteristic(s)), the measurements of the one or more characteristics of the workpieces may be used to alter one or more parameters of the process such that additional workpieces manufactured by the process have acceptable characteristic(s).

One common metrology process is 3D optical metrology, which uses light to precisely measure the 3D profile of a sample or device. Specifically, interferometric 3D metrology relies on phase measurement of light to extract height information of samples, i.e., sample topography. In many cases, the sample may be fully or partially coated with one or more thin transparent or semi-transparent layers. These thin layers affect both the phase and amplitude of the reflected light, thus posing a challenge on the extraction of phase information.

Several approaches may be used to compensate for the effect of these transparent layers, which typically involves additional information on the layers'properties. One example is the incorporation of thin film metrology (TFM) to characterize the layers'structure and/or optical properties, and finally adjust the phase measurement accordingly. However, in some combinations of light wavelength and layer structure, the layers optical response results in destructive interference of the reflected light, thus severely impacting the amount of collected signal, and consequently the precision of the metrology system. Nonetheless, at the vicinity of these combinations, the phase of the reflected light changes rapidly, which makes common compensation method highly sensitive to sample properties (e.g., layer thickness), and in many cases practically inapplicable.

Therefore, what is needed is an improved system and method for inspecting and characterizing transparent features.

### BRIEF SUMMARY OF THE DISCLOSURE

An embodiment of the present disclosure provides a system. The system may comprise a stage configured to support a workpiece. The system may further comprise an illumination subsystem. The illumination subsystem may comprise a light source configured to emit light split into a reference beam and an object beam. The illumination subsystem may further comprise a beam steering element disposed in a path of the object beam. The beam steering element may be configured to direct the object beam to the workpiece. The system may further comprise a detection subsystem. The detection subsystem may comprise a first beam splitter configured to combine the reference beam with the object beam transmitted through the workpiece or reflected by the workpiece into a combined beam. The detection subsystem may further comprise a detector configured to generate a detection signal based on the combined beam received from the first beam splitter. The system may further comprise a processor in electronic communication with the illumination subsystem and the detection subsystem. The processor may be configured to receive the detection signal from the detector as the stage scans relative to the object beam for a scan length. The processor may be further configured to send instructions to the illumination subsystem to adjust an effective illumination wavelength of the object beam directed to the workpiece for a portion of the scan length in an area of destructive interference in the workpiece. The processor may be further configured to generate an interference image of the workpiece based on the detection signal received for the entire scan length.

In some embodiments, the processor may be further configured to determine amplitude and phase information of the object beam based on the interference image. The processor may be further configured to generate a 3D map of the workpiece based on the amplitude and phase information of the object beam, an illumination wavelength of the object beam, and an angle of incidence of the object beam.

In some embodiments, the processor may be further configured to receive external thin film metrology information of the workpiece. The processor may be further configured to determine the area of destructive interference in the workpiece based on the external thin film metrology information of the workpiece.

In some embodiments, the processor may be further configured to determine optimal illumination properties for the area of destructive interference in the workpiece based on the external thin film metrology information of the workpiece. The processor may be further configured to generate the instructions to adjust the effective illumination wavelength of the object beam directed to the workpiece based on the optimal illumination properties.

In some embodiments, the processor may be further configured to compare a level of the detection signal to a preset threshold. The processor may be further configured to generate the instructions to adjust the effective illumination wavelength of the object beam directed to the workpiece when the level of the detection signal is less than the preset threshold.

In some embodiments, the processor may be further configured to generate the instructions to adjust the effective illumination wavelength of the object beam directed to the workpiece according to a sequence of illumination modalities. The effective illumination wavelength of the object beam may be different among each illumination modality of the sequence of illumination modalities. The processor may be further configured to determine optimal illumination properties for the area of destructive interference in the workpiece based on a highest level of the detection signal among the sequence of illumination modalities. The interference image of the workpiece may be generated based on the detection signal received with the optimal illumination properties for each portion of the scan length.

In some embodiments, the light source may comprise a tunable light source configured to adjust a wavelength of the light emitted by the light source to adjust the effective illumination wavelength of the object beam directed to the workpiece.

In some embodiments, the beam steering element may be further configured to adjust an angle of incidence of the object beam relative to a first side of the workpiece to adjust the effective illumination wavelength of the object beam transmitted through the workpiece.

In some embodiments, the illumination subsystem may comprise at least two light sources. The effective illumination wavelength of the object beam may be different among the light emitted by each of the at least two light sources.

In some embodiments, the illumination subsystem may further comprise a polarizer configured to adjust a polarization of the light emitted by the light source to adjust the effective illumination wavelength of the object beam directed to the workpiece.

In some embodiments, the illumination subsystem may further comprise a diffraction grating disposed in the path of the object beam and configured to multiplex light from multiple angles of incidence to be directed to the workpiece. The interference image of the workpiece may be generated based on the detection signal received with a highest level among the multiple angles of incidence.

In some embodiments, the illumination subsystem may be configured to switch between at least two illumination modalities based on the instructions to adjust the effective illumination wavelength of the object beam directed to the workpiece.

In some embodiments, the at least two illumination modalities may comprise a first illumination modality and a second illumination modality. The processor may be further configured to send instructions to the illumination subsystem to switch from the first illumination modality to the second illumination modality to adjust the effective illumination wavelength of the object beam directed to the workpiece for the portion of the scan length in the area of destructive interference in the workpiece. The processor may be further configured to send instructions to the illumination subsystem to switch from the second illumination modality to the first illumination modality to adjust the effective illumination wavelength of the object beam directed to the workpiece for a portion of the scan length outside of the area of destructive interference in the workpiece.

Another embodiment of the present disclosure provides a method. The method may comprise emitting light from a light source. The light may be split into a reference beam and an object beam. The method may further comprise directing, with a beam steering element, the object beam to a workpiece supported by a stage. The method may further comprise combining, with a beam splitter, the reference beam and the object beam transmitted through the workpiece or reflected by the workpiece into a combined beam. The method may further comprise generating, with a detector, a detection signal based on the combined beam received from the beam splitter. The method may further comprise receiving, with a processor, the detection signal from the detector as the stage scans relative to the object beam for a scan length. The method may further comprise adjusting an effective illumination wavelength of the object beam directed to the workpiece for a portion of the scan length in an area of destructive interference in the workpiece. The method may further comprise generating, with the processor, an interference image of the workpiece based on the detection signal received for the entire scan length.

In some embodiments, the method may further comprise determining, with the processor, amplitude and phase information of the object beam based on the interference image. The method may further comprise generating, with the processor, a 3D map of the workpiece based on the amplitude and phase information of the object beam, an illumination wavelength of the object beam, and an angle of incidence of the object beam.

In some embodiments, before adjusting the effective illumination wavelength of the object beam directed to the workpiece, the method may further comprise receiving, with the processor, external thin film metrology information of the workpiece. The method may further comprise determining, with the processor, the area of destructive interference in the workpiece based on the external thin film metrology information of the workpiece.

In some embodiments, before adjusting the effective illumination wavelength of the object beam directed to the workpiece, the method may further comprise determining, with the processor, optimal illumination properties for the area of destructive interference in the workpiece based on the external thin film metrology information of the workpiece. The method may further comprise generating, with the processor, instructions to adjust the effective illumination wavelength of the object beam directed to the workpiece based on the optimal illumination properties.

In some embodiments, the method may further comprise comparing, with the processor, a level of the detection signal to a preset threshold. The method may further comprise generating, with the processor, instructions to adjust the effective illumination wavelength of the object beam directed to the workpiece when the level of the detection signal is less than the preset threshold.

In some embodiments, the method may further comprise generating, with the processor, instructions to adjust the effective illumination wavelength of the object beam directed to the workpiece according to a sequence of illumination modalities. The effective illumination wavelength of the object beam may be different among each illumination modality of the sequence of illumination modalities. The method may further comprise determining optimal illumination properties for the area of destructive interference in the workpiece based on a highest level of the detection signal among the sequence of illumination modalities. The interference image of the workpiece may be generated based on the detection signal received with the optimal illumination properties for each portion of the scan length.

In some embodiments, adjusting the effective illumination wavelength of the object beam directed to the workpiece may comprise switching from a first illumination modality to a second illumination modality to adjust the effective illumination wavelength of the object beam directed to the workpiece for the portion of the scan length in the area of destructive interference in the workpiece, and switching from the second illumination modality to the first illumination modality to adjust the effective illumination wavelength of the object beam directed to the workpiece for a portion of the scan length outside of the area of destructive interference in the workpiece.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of a system according to an embodiment of the present disclosure;

FIG. 2A is a diagram of a system according to another embodiment of the present disclosure;

FIG. 2B is a diagram of a system according to another embodiment of the present disclosure;

FIG. 3 is a diagram of a system according to another embodiment of the present disclosure;

FIG. 4 is a diagram of a system according to another embodiment of the present disclosure;

FIG. 5 is a diagram of a system according to another embodiment of the present disclosure;

FIG. 6 is a flowchart of a method according to an embodiment of the present disclosure;

FIG. 7 is a flowchart of a method according to another embodiment of the present disclosure;

FIG. 8 is a flowchart of a method according to another embodiment of the present disclosure;

FIG. 9 is a flowchart of a method according to another embodiment of the present disclosure;

FIG. 10 is a flowchart of a method according to another embodiment of the present disclosure; and

FIG. 11 is a flowchart of a method according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

An embodiment of the present disclosure provides a system 100. The system 100 may be configured to perform one or more inspection or metrology processes on a workpiece 101. The workpiece 101 may be, for example, a semiconductor wafer, substrate, printed circuit board (PCB), integrated circuit (IC), flat panel display (FPD), or other type of workpiece. The workpiece 101 may be made of transparent or semi-transparent materials, such as glass, silicon, or other materials. In some embodiments, the workpiece 101 may be made of a non-transparent material, but is overcoated by one or more transparent or semi-transparent layers, such as glass, silicon nitride, polymers, or other materials. Some materials, such as Si, may be considered as transparent or non-transparent depending on the illumination wavelength being used. For example, Si may be considered non-transparent to visible light, but it may be considered transparent to infrared light. The workpiece 101 may include embedded features that have differences in refractive index. For example, the workpiece 101 may include co-packaged optics (CPO), through silicon vias (TSV), through glass vias (TGV), advanced IC substrates (e.g., Si, SiC, or other optically transparent substrates), or on-chip photonic devices (e.g., silicon photonics). As further described below, the system 100 may be configured to mitigate areas of destructive interference in the workpiece 101 by adjustment of the effective illumination wavelength of light illuminating the workpiece 101, as further described below.

The system 100 may comprise a stage 110 configured to support the workpiece 101. The stage 110 may include one or more motors or actuators configured to move the workpiece 101 in one or more in-plane directions (e.g., along an x-axis and/or along a y-axis) and/or out-of-plane direction (e.g., along a z-axis). In some embodiments, the stage 110 may include one or more motors or actuators configured to rotate the workpiece 101 about any of the x-axis, the y-axis, or the z-axis.

The system 100 may further comprise an illumination subsystem 105. The illumination subsystem 105 may comprise a light source 120. The light source 120 may be configured to emit light 121. In some embodiments, the light source 120 may be a tunable light source, e.g., tunable laser sources, diode-laser sources with temperature-control (TEC), or other tunable light sources. In some embodiments, the light source 120 may be a broadband light source, e.g., a white-light LED, a broadband laser, or other broadband light source. In some embodiments, the light source 120 may be coupled to a wavelength tuning device, which may be comprised of an adjustable filter such as a linearly variable filter, an acousto-optic-filter (AOF), a grating/slit combination or other adjustable filters. In some embodiments, the system 100 may further comprise a second beam splitter 115 configured to split the light 121 from the light source 120 into a reference beam 122 and an object beam 123. The wavelength of the light 121 emitted by the light source 120 may depend on the type of workpiece 101 being inspected. For example, visible light (having a wavelength in a range of 400 to 600 nm) may be used for glass substrates, and infrared light (having a wavelength in a range of 900 to 1100 nm) may be used for silicon substrates. The wavelength of the light 121 may vary so long as it is transmissive enough and sensitive enough to the refractive indexes of features of the workpiece 101. For setups where light is reflected from the workpiece 101, the wavelength of the light 121 may be varied as long as the workpiece absorptance is sufficiently low.

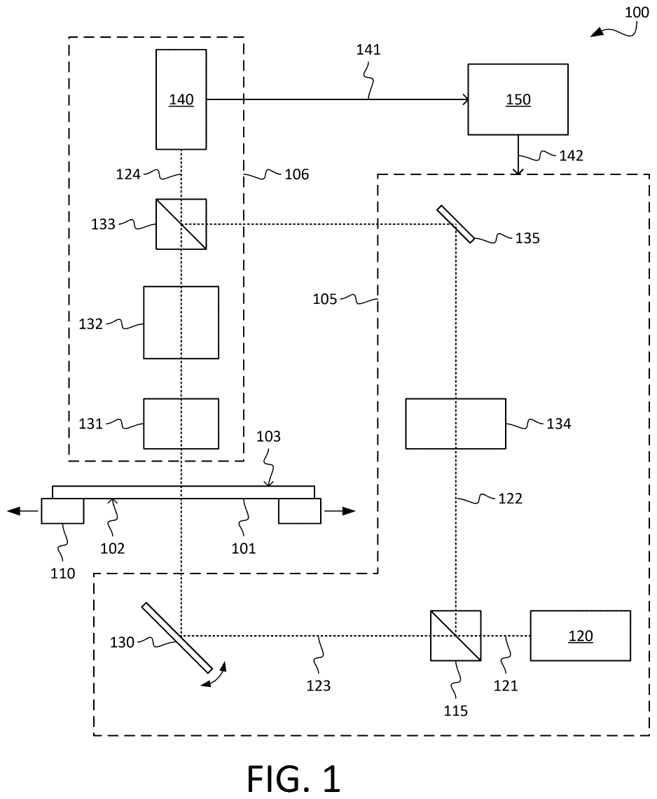

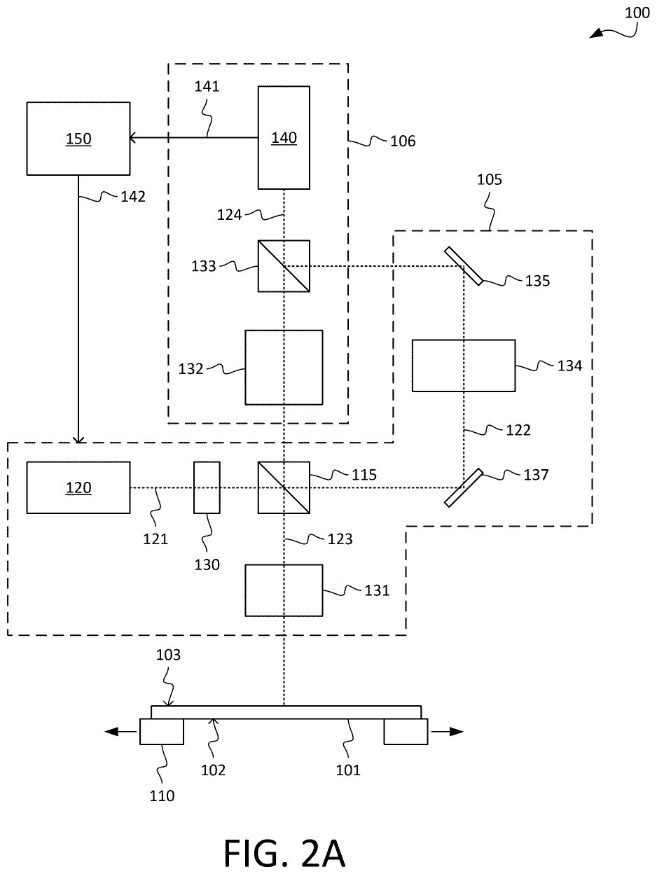

The stage 110 may be positioned such that the object beam 123 is transmitted through the workpiece 101. For example, the object beam 123 may be directed at a first side 102 of the workpiece 101 and transmitted through a second side 103 of the workpiece 101, as shown in FIG. 1. Alternatively, the stage 110 may be positioned such that the object beam 123 is reflected by the workpiece 101. For example, the object beam 123 may be directed at the second side 103 of the workpiece 101, as shown in FIG. 2A and FIG. 2B.

The illumination subsystem 105 may further comprise a beam steering element 130. The beam steering element may be configured to direct the object beam 123 at the first side 102 of the workpiece 101 to be transmitted through the second side 103 of the workpiece 101. Alternatively, the beam steering element may be configured to direct the object beam 123 at the second side 103 of the workpiece 101 to be reflected by the workpiece 101. In some embodiments, the beam steering element 130 may be a static element (e.g., a mirror), which directs the object beam toward the workpiece 101 with a fixed angle of incidence. Alternatively, the beam steering element 130 may be a dynamic element configured to adjust the angle of incidence of the object beam 123 on the workpiece 101. For example, the beam steering element 130 may ensure normal incidence of the object beam 123 on the first side 102 or the second side 103 of the workpiece 101 or may adjust the angle of incidence to one or more oblique angles.

In some embodiments, the beam steering element 130 may be disposed before the second beam splitter 115, as shown in FIG. 2A. Alternatively, the beam steering element 130 may be disposed after the second beam splitter 115, as shown in FIG. 2B. Accordingly, the illumination subsystem 105 may further comprise a third beam splitter 116 configured to direct the object beam 123 at the second side 103 of the workpiece 101 to be reflected by the workpiece 101.

In some embodiments, the beam steering element 130 may comprise a fast scanning mirror (FSM). An FSM can rapidly change the angle of a beam by reflecting it off a mirror that can tilt in different directions. When used in conjunction with an infinity-corrected objective, the FSM can focus and scan the beam at the back focal plane, resulting in a collimated beam that can be steered precisely. An FSM can provide high-speed and precise control of the beam angle, making it suitable for dynamic applications.

In some embodiments, the beam steering element 130 may comprise a galvanometer mirror. Similar to FSMs, galvanometer mirrors use rotating mirrors driven by galvanometers to steer the beam. These mirrors can achieve high-speed scanning and are often used in laser scanning systems. These mirrors can also offer fast response times and high precision, suitable for applications requiring rapid beam steering.

In some embodiments, the beam steering element 130 may comprise an acousto-optic deflector (AOD). AODs use sound waves to create a diffraction grating in an acousto-optic material. By changing the frequency of the sound waves, the angle of the diffracted beam can be controlled. AODs can also offer fast and precise beam steering with the ability to control the beam angle electronically.

In some embodiments, the beam steering element 130 may comprise a micro-electro-mechanical system (MEMS) mirror. MEMS mirrors are tiny mirrors that can tilt in multiple directions using electrostatic or electromagnetic forces. These mirrors can be used to steer the beam with high precision. MEMS mirrors can provide compact and low-power solutions for beam steering, suitable for portable and miniaturized systems.

In some embodiments, the beam steering element 130 may comprise an electro-optic beam deflector. These devices use the electro-optic effect to change the refractive index of a material, thereby steering the beam. By applying a voltage, the beam can be deflected to different angles. These devices can offer fast response times and precise control, suitable for high-speed applications.

While several exemplary types of beam steering elements 130 are described herein, each may achieve precise and dynamic control of the beam angle, and the type of beam steering element 130 may be selected depending on the specific application requirements. In addition, some types of beam steering elements 130 (e.g., AODs and electro-optic beam deflectors) may utilize optical relays to provide a full range of AOIs.

The system 100 may further comprise a detection subsystem 106. The detection subsystem 106 may comprise first beam splitter 133. The first beam splitter 133 may be configured to combine the reference beam 122 with the object beam 123 transmitted through the workpiece 101 into a combined beam 124. The detection subsystem 106 may further comprise a detector 140. The detector 140 may be configured to detect the combined beam 124 received from the first beam splitter 133. The detector 140 may be, for example an area sensor, used to capture a full field-of-view image of the workpiece 101. Alternatively, the detector 140 may be a line-sensor, TDI, or single-point sensor, used to capture a slice or a single point image of the workpiece 101.

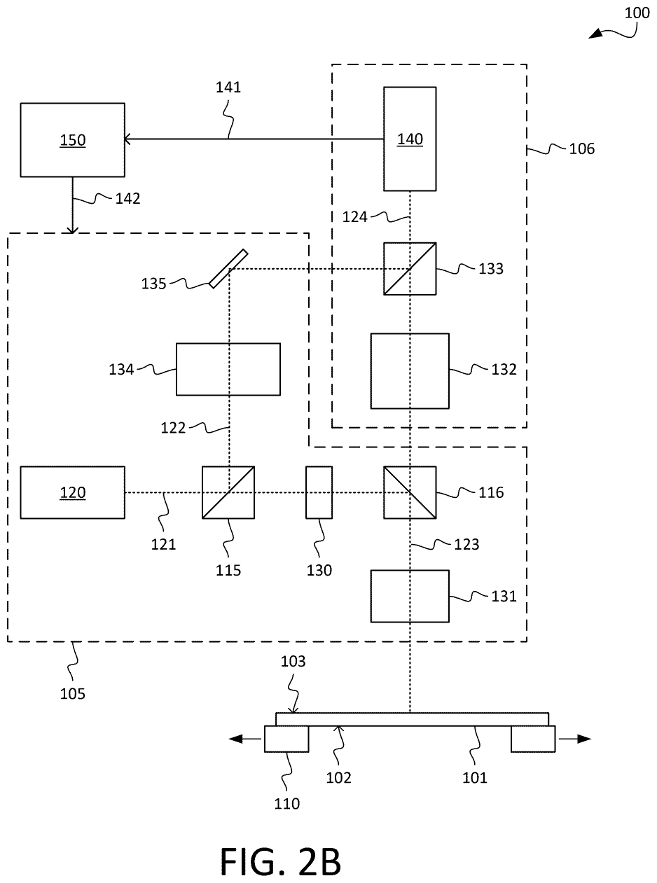

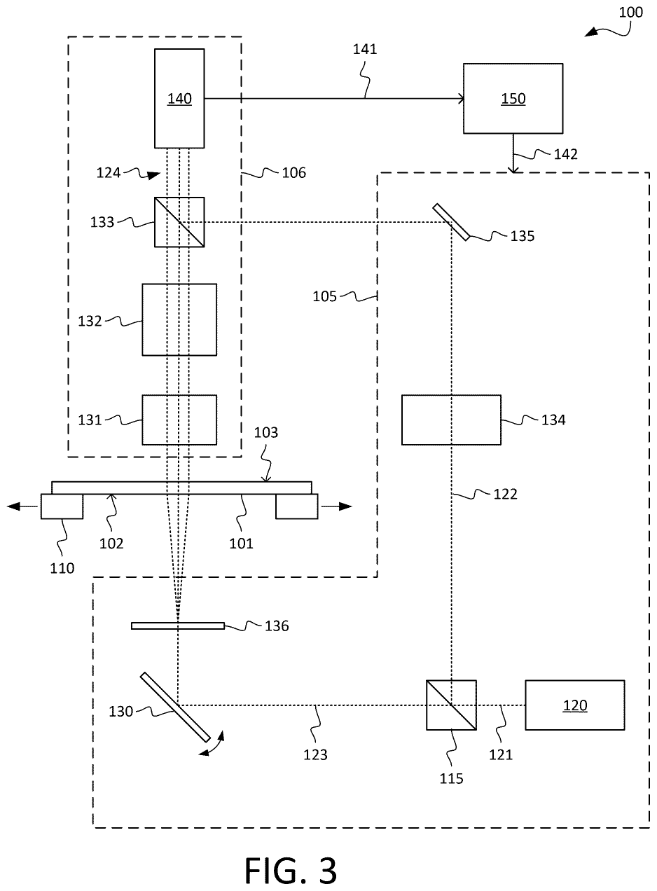

The system 100 may further comprise any number of other optical elements disposed in the path of the reference beam 122 and/or the object beam 123 and is not limited herein. For example, the illumination subsystem 105 may further comprise a beam expander 134 disposed in the path of the reference beam 122. The illumination subsystem 105 may further comprise a reference mirror 135 disposed in the path of the reference beam 122, which may be configured to direct the reference beam 122 to the beam splitter 133. A second reference mirror 137 may be disposed in the path of the reference beam 122, which may be configured to direct the reference beam 122 to the beam expander 134 (as shown in FIG. 2A) or directly to the reference mirror 135. In a case where the beam steering element 130 is disposed after the second beam splitter 115 (as shown in FIG. 2B), the illumination subsystem 105 may further comprise a delay line (mirrors, etc.) disposed in the path of the reference beam 122 configured to adjust the optical path difference between the reference beam 122 and the object beam 123. The illumination subsystem 105 may further comprise a diffraction grating 136 disposed in the path of the object beam 123, which may be configured to multiplex light from multiple angles of incidence to be transmitted through the workpiece 101, as shown in FIG. 3. The illumination subsystem 105 may further comprise a polarizer 125 disposed in the path of the light 121 emitted by the light source 120, as shown in FIG. 4, which may be configured to adjust a polarization of the light 121 to adjust the effective illumination wavelength of the object beam 123 transmitted through the workpiece 101. The illumination subsystem 105 may further comprise a beam expander, collimating optics, diffractive optics for phase uniformity, intensity filters, variable length motion controllers to match the optical path difference changes, and/or polarization rotation elements for optimal interference of the reference beam 122 with the object beam 123.

The system 100 may further comprise any number of other optical elements disposed in the path of the object beam 123 transmitted through the workpiece 101 and is not limited herein. For example, an objective lens 131 may be disposed in the path of the object beam 123 transmitted through the workpiece 101 or reflected by the workpiece 101. A tube lens 132 may be further provided in the path of the object beam 123 transmitted through the workpiece 101 or reflected by the workpiece 101. The detection subsystem 106 may further comprise diffractive optical elements for phase control and/or a spatial light modulator (SLM) for phase modifications of the object beam 123.

The system 100 may further comprise a processor 150. The processor 150 may include a microprocessor, a microcontroller, field programmable gate array (FPGA), or other devices. The processor 150 may be coupled to the components of the system 100 in any suitable manner (e.g., via one or more transmission media, which may include wired and/or wireless transmission media) such that the processor 150 can receive output. The processor 150 may be configured to perform a number of functions using the output. An inspection tool can receive instructions or other information from the processor 150. The processor 150 optionally may be in electronic communication with another inspection tool, a metrology tool, a repair tool, or a review tool (not illustrated) to receive additional information or send instructions.

The processor 150 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 150 may be disposed in or otherwise part of the system 100 or another device. In an example, the processor 150 may be part of a standalone control unit or in a centralized quality control unit. Multiple processors 150 may be used, defining multiple subsystems of the system 100.

The processor 150 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 150 to implement various methods and functions may be stored in readable storage media, such as a memory.

If the system 100 includes more than one subsystem, then the different processors 150 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 150 may be configured to perform a number of functions using the output of the system 100 or other output. For instance, the processor 150 may be configured to send the output to an electronic data storage unit or another storage medium. The processor 150 may be further configured as described herein.

The processor 150 may be configured according to any of the embodiments described herein. The processor 150 also may be configured to perform other functions or additional steps using the output of the system 100 or using images or data from other sources.

The processor 150 may be communicatively coupled to any of the various components or sub-systems of system 100 in any manner known in the art. For example, the processor 150 may be in electronic communication with the illumination subsystem 105 and the detection subsystem 106. Moreover, the processor 150 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 150 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 150 (or computer subsystem) or, alternatively, multiple processors 150 (or multiple computer subsystems). Moreover, different sub-systems of the system 100 may include one or more computing or logic systems. Therefore, the above description should not be interpreted as a limitation on the present disclosure but merely an illustration.

The processor 150 may be in electronic communication with the stage 110. For example, the processor 150 may be configured to send instructions to the one or more actuators of the stage 110 to move the stage 110 relative to the object beam 123 (e.g., along the x-axis and/or along the y-axis) to adjust the alignment of the object beam 123 relative to the first side 102 of the workpiece 101 and to move for the scan length. The position of the stage 110 may be further adjusted (i.e., along the z-axis) based on the thickness of the workpiece 101. The stage 110 may move in a scanning mode, where the stage 110 continuously moves relative to the object beam 123. Alternatively, the stage 110 may move in a step-and-settle mode, where the stage 110 incrementally moves to different scan positions relative to the object beam 123.

The processor 150 may be in electronic communication with the light source 120. For example, the processor 150 may be configured to send instructions to the light source 120 to emit the light 121. In some embodiments, the light source 120 may comprise a tunable light source configured to adjust a wavelength of the light 121 emitted by the light source 120, which can adjust the effective illumination wavelength of the object beam 123 transmitted through the workpiece 101. Accordingly, the processor 150 may be further configured to send instructions to the light source 120 to adjust the wavelength of the light 121. The effective illumination wavelength of the object beam 123 may be adjusted while the stage 110 is moving (in the scanning mode) or between movements (in the step-and-settle mode).

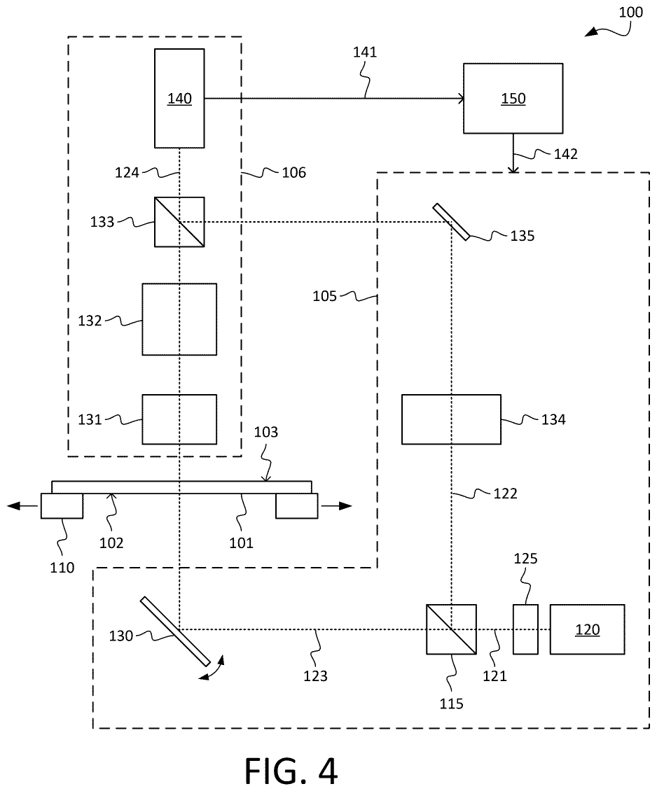

In some embodiments, the illumination subsystem 105 may comprise at least two light sources 120. For example, the illumination subsystem 105 may comprise a first light source 120a configured to emit first light 121a and a second light source 120b configured to emit second light 121b, as shown in FIG. 5. The effective illumination wavelength of the object beam 123 may be different among the first light source 120a and the second light source 120b, based on differences in wavelength of the first light 121a and the second light 121b. Accordingly, the processor 150 may further be configured to send instructions to one of the first light source 120a or the second light source 120b to emit first light 121a or second light 121b to provide a particular effective illumination wavelength of the object beam 123.

In some embodiments, the processor 150 may be in electronic communication with the polarizer 125. The processor 150 may be further configured to send instructions to the polarizer 125 to adjust the polarization of the light 121 emitted by the light source 120 to provide a particular effective illumination wavelength of the object beam 123.

The processor 150 may be in electronic communication with the beam steering element 130. For example, the processor 150 may be configured to send instructions to the beam steering element 130 to adjust the angle of incidence (AOI) of the object beam 123 relative to the workpiece 101, which can adjust the effective illumination wavelength of the object beam 123 transmitted through the workpiece 101 or reflected by the workpiece 101.

The processor 150 may be in electronic communication with the detector 140. For example, the processor 150 may be configured to receive the detection signal 141 from the detector 140 based on the combined beam 124 detected by the detector 140 as the stage 110 scans relative to the object beam 123 for the scan length. The processor 150 may continuously receive the detection signal 141 from the detector 140 as the stage 110 scans relative to the object beam 123 for the scan length.

The processor 150 may be further configured to send instructions 142 to the illumination subsystem 105 to adjust the effective illumination wavelength of the object beam 123 transmitted through the workpiece 101 for a portion of the scan length in an area of destructive interference in the workpiece 101. For example, the processor 150 may be configured to send instructions 142 to adjust the wavelength of the light 121 emitted by the light source 120 (e.g., by adjusting a tunable light source or switching between different light sources) or the polarization of the light 121 emitted by the light source 120 (e.g., by adjusting the polarizer 125) to adjust the effective illumination wavelength of the object beam 123 transmitted through the workpiece 101 or reflected by the workpiece 101. Alternatively, or additionally, the processor 150 may be configured to send instructions 142 to adjust the angle of incidence of the object beam 123 onto the workpiece 101 by adjusting the beam steering element 130 to adjust the effective illumination wavelength of the object beam 123 transmitted through the workpiece 101 or reflected by the workpiece 101.

In some embodiments, the illumination subsystem 105 may be configured to switch between at least two illumination modalities based on the instructions 142 to adjust the effective illumination wavelength of the object beam 123. Each illumination modality may have a different wavelength or polarization of the light 121 emitted by the light source 120 or different angle of incidence of the object beam 123 onto the first side 102 or the second side 103 of the workpiece 101. In an instance, the at least two illumination modalities may comprise a first illumination modality and a second illumination modality. The processor 150 may be further configured to send instructions 142 to the illumination subsystem 105 to switch from the first illumination modality to the second illumination modality to adjust the effective illumination wavelength of the object beam 123 for the portion of the scan length in the area of destructive interference in the workpiece 101. Then, the processor 150 may be further configured to send instructions 142 to the illumination subsystem 105 to switch from the second illumination modality to the first illumination modality to adjust the effective illumination wavelength of the object beam 123 for a portion of the scan length outside of the area of destructive interference in the workpiece 101. Accordingly, the processor 150 may control the illumination subsystem 105 to switch to an appropriate illumination modality having an effective illumination wavelength of the object beam 123 that minimizes and/or avoids destructive interference.

In some embodiments, the processor 150 may be configured to receive external thin film metrology (TFM) information of the workpiece 101. The external TFM information of the workpiece 101 may be collected by another inspection or metrology tool communicatively coupled to the system 100. The external TFM information may indicate expected areas of destructive interference in the workpiece 101. Accordingly, the processor 150 may be configured to determine the portion of the scan length in the area of destructive interference in the workpiece based on the external TFM information. The processor 150 may be further configured to determine optimal illumination properties for the area of destructive interference in the workpiece 101 based on the external TFM information of the workpiece 101. For example, the external TFM information may indicate an appropriate effective illumination wavelength of the object beam 123 that can reduce or avoid destructive interference in the expected area of destructive interference in the workpiece 101. Accordingly, the processor 150 may be configured to generate the instructions 142 to adjust the effective illumination wavelength of the object beam 123 based on the optimal illumination properties from the external TFM information.

In some embodiments, the processor 150 may be configured to determine the area of destructive interference in the workpiece 101 without external TFM information. For example, the processor 150 may be configured to compare a level of the detection signal 141 received from the detector 140 to a preset threshold as the stage 110 scans relative to the object beam 123. When the level of the detection signal 141 is less than the preset threshold, this may indicate an area of destructive interference in the workpiece 101. Accordingly, the processor 150 may generate the instructions 142 to adjust the effective illumination wavelength of the object beam 123 when the level of the detection signal 141 is less than the preset threshold.

In some embodiments, the processor 150 may be configured to periodically adjust the effective illumination wavelength of the object beam 123 through the entire scan length. For example, the processor 150 may be configured to generate the instructions 142 to adjust the effective illumination wavelength of the object beam 123 according to a sequence of illumination modalities. The effective illumination wavelength of the object beam 123 may be different among each illumination modality of the sequence of illumination modalities. The sequence of illumination modalities may be timed such that each position of the stage 110 in the scan length is illuminated with each illumination modality. The transition between modalities may be fast enough to acquire at least one overlap at each modality. For example, the modality-transition time may be less than the acquisition time, such that there may be an overlap of at least 50% for each modality between consecutive acquisitions in the scan. For three-fold overlap (e.g., 67% overlap) and two modalities, the maximum transition time may be 1.5 times the acquisition time. Accordingly, each area of the workpiece 101 (including any areas with destructive interference) may be illuminated with an appropriate effective illumination wavelength of the object beam 123 provided by at least one of the illumination modalities.

The processor 150 may be configured to generate an interference image of the workpiece 101 based on the detection signal 141 received for the entire scan length of the stage 110. With the effective illumination wavelength of the object beam 123 adjusted in the areas of destructive interference of the workpiece 101, the accuracy of the interference image may be improved.

In some embodiments, where the effective illumination wavelength is periodically adjusted through the entire scan length, the processor 150 may be further configured to determine optimal illumination properties for the area of destructive interference in the workpiece 101 based on a highest reflectivity level of the detection signal 141 among the sequence of illumination modalities. Accordingly, the processor 150 may generate the interference image of the workpiece 101 based on the detection signal 141 received with the optimal illumination properties for each portion of the scan length, ignoring parts of the detection signal 141 generated from illumination modalities having low reflectivity levels.

In some embodiments, where a diffraction grating 136 is disposed in the path of the object beam 123 and is configured to multiplex light from multiple angles of incidence to be transmitted through the workpiece 101, the processor 150 may be further configured to determine optimal illumination properties for the area of destructive interference in the workpiece 101 based on a highest reflectivity level of the detection signal 141 among the multiple angles of incidence. Accordingly, the processor 150 may generate the interference image of the workpiece 101 based on the detection signal 141 received with the optimal illumination properties for each portion of the scan length, ignoring parts of the detection signal 141 generated from angles of incidence having low reflectivity levels.

The illumination modality may affect 3D map reconstruction. Accordingly, the processor 150 may be configured to use the modality properties (e.g., AOI information) as input for 3D map reconstruction. The reconstruction method may include, for example, digital focus variation, wavelength phase unwrapping, or other methods to generate a 3D map of the workpiece 101. For example, the processor 150 may be configured to generate a 3D map of the workpiece 101 based on at least one phase image or a plurality of phase images at different illumination wavelengths or modalities. The 3D map of the workpiece 101 may indicate heights of features within the workpiece 101, which can be used for mapping and identification of local features and defects.

In some embodiments, the processor 150 may be configured to determine amplitude and phase information of the object beam 123 based on the interference image. The processor 150 may use a filtered backpropagation algorithm to retrieve the amplitude and phase of the object beam 123. In some embodiments, the filtered backpropagation algorithm may use or not use noise reduction methods. The processor 150 may be further configured to generate, using numerical propagation, a plurality of depth images of the workpiece 101 based on the amplitude and phase information of the object beam 123. For example, the processor 150 may apply the Angular Spectrum or Fresnel Diffraction method to extract amplitude data and determine the specific geometry of each plane to generate the plurality of depth images of the workpiece 101. The processor 150 may be further configured to generate a 3D map of the workpiece 101 based on the plurality of depth images. The 3D map of the workpiece 101 may indicate heights of features within the workpiece 101, which can be used for mapping and identification of local features and defects.

With the system 100, measurements of the workpiece 101 can be improved, due to mitigation of very low reflectivity at regions where the reflected light destructively interferes with the transparent layers of the workpiece 101 and mitigation of very high phase sensitivity at regions where the reflected light destructively interferes within the transparent layers due to the dynamic adjustment of the effective illumination wavelength of the object beam 123. In some embodiments, periodic modality cycling can increase the measurement range by combining different modalities. The transmission mode can also be used to localize transparent features in the workpiece 101. In addition, these improvements can be applied to a wide variety of structures and do not affect the overall throughput of the system 100.

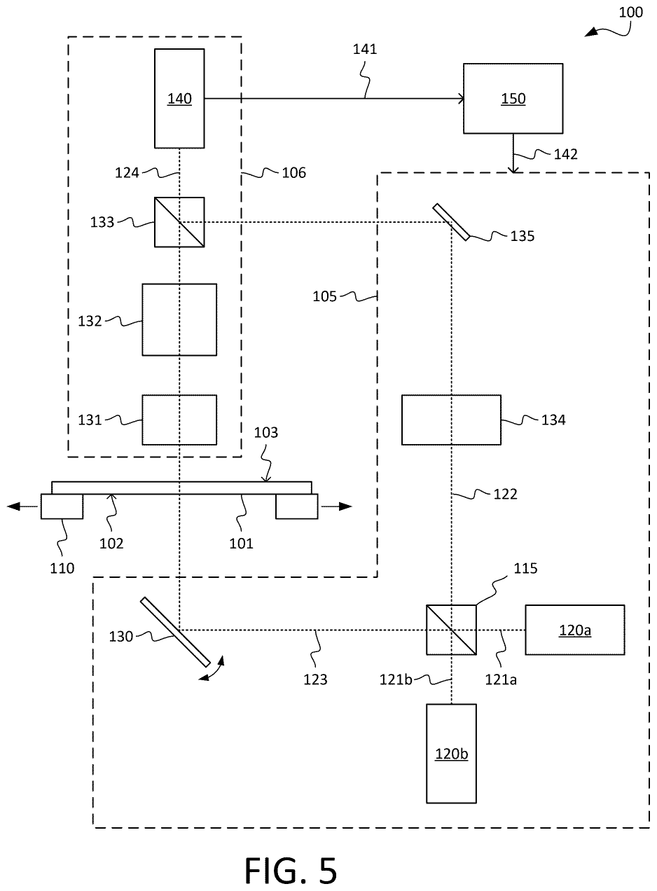

Another embodiment of the present disclosure provides a method 200. As shown in FIG. 6, the method 200 may comprise the following steps.

At step 210, light is emitted from a light source. The light may be split into a reference beam and at least one object beam.

At step 220, a beam steering element directs the object beam to a workpiece supported by a stage. In some embodiments, the object beam may be transmitted through the workpiece. Alternatively, the object beam may be reflected by the workpiece.

At step 230, a beam splitter combines the reference beam with the object beam transmitted through the workpiece or reflected by the workpiece into a combined beam.

At step 240, a detector generates a detection signal based on the combined beam received from the beam splitter.

At step 250, a processor receives the detection signal from the detector as the stage scans relative to the object beam for a scan length.

At step 260, an effective illumination wavelength of the object beam directed to the workpiece is adjusted for a portion of the scan length in the area of destructive interference in the workpiece. The effective illumination wavelength of the object beam can be adjusted by adjusting a wavelength of the light emitted by the light source (e.g., using a tunable light source or selecting between two or more different light sources), adjusting a polarization of the light emitted by the light source (e.g., using a polarizer disposed in the path of the light emitted by the light source), and/or adjusting an angle of incidence of the object beam on the workpiece (e.g. using the beam steering element).

At step 270, a processor generates an interference image of the workpiece based on the detection signal received for the entire scan length.

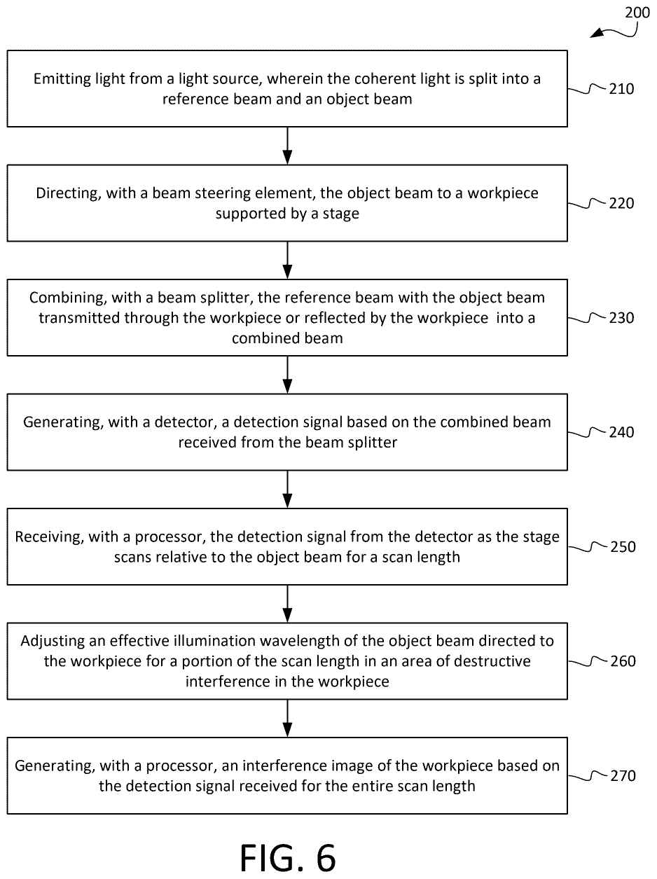

In some embodiments, the method 200 may further comprise the following steps shown in FIG. 7.

At step 280, the processor determines amplitude and phase information of the object beam based on the interference image.

At step 290, the processor generates a 3D map of the workpiece based on the phase and amplitude information of the object beam, the illumination wavelength of the object beam, and the angle of incidence of the object beam. The 3D map may be generated by digital refocusing, by calculation of the optical path difference, or by other methods (e.g., point spread function (PSF) engineering, machine learning, etc.). In an instance, the processor may generate, using numerical propagation, a plurality of depth images of the workpiece based on the amplitude and phase information of the object beam and determine a focus score of each pixel of the plurality of depth images. Accordingly, the processor may generate the 3D map of the workpiece based on the focus score of each pixel of the plurality of depth images.

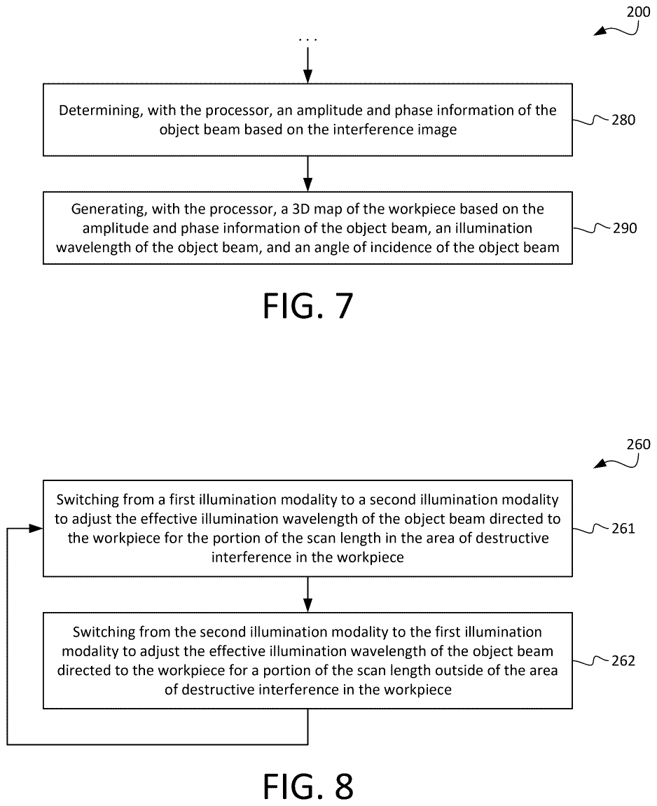

In some embodiments, step 260 may comprise the following steps shown in FIG. 8.

At step 261, the illumination switches from a first illumination modality to a second illumination modality to adjust the effective illumination wavelength of the object beam transmitted through the workpiece for the portion of the scan length in the area of destructive interference in the workpiece.

At step 262, the illumination switches from the second illumination modality to the first illumination modality to adjust the effective illumination wavelength of the object beam transmitted through the workpiece for a portion of the scan length outside of the area of destructive interference in the workpiece. After step 262, step 261 may be performed again, to switch back to the second illumination modality for another portion of the scan in an area of destructive interference in the workpiece. Accordingly, steps 261 and 262 may be performed in alternating fashion to switch between the two illumination modalities.

In some embodiments, there may be more than two illumination modalities, and step 260 may comprise switching between any one of the illumination modalities to provide the appropriate effective illumination wavelength of the object beam for the area of the workpiece under scan.

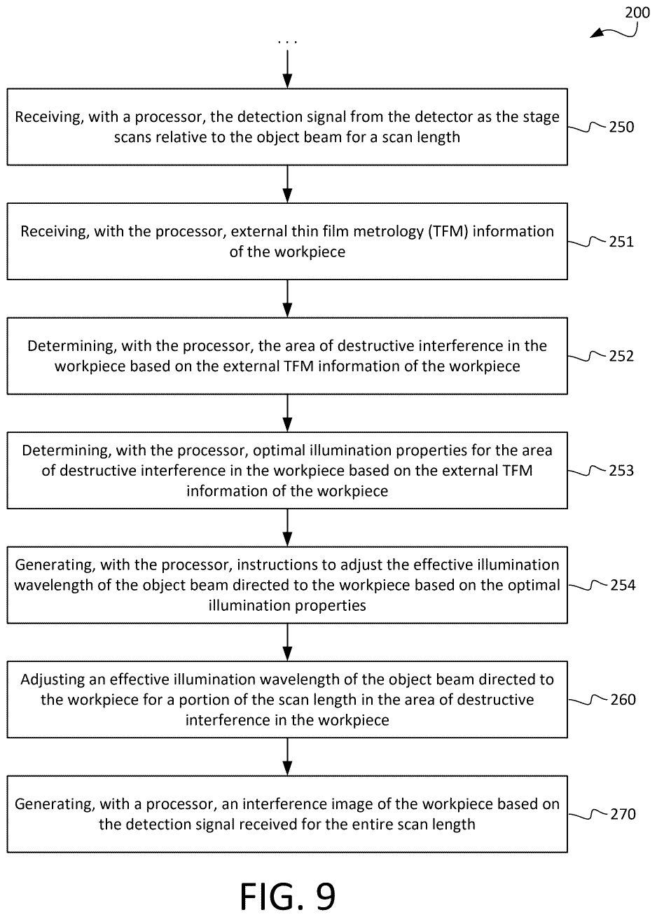

In some embodiments, before step 260, the method 200 may further comprise the following steps shown in FIG. 9.

At step 251, the processor receives external thin film metrology (TFM) information of the workpiece.

At step 252, the processor determines the area of destructive interference in the workpiece based on the external TFM information of the workpiece. Accordingly, step 260 may be performed when the stage has reached a position within the scan length where the object beam is directed to the area of destructive interference in the workpiece.

In some embodiments, before step 260, the method 200 may further comprise the following additional steps.

At step 253, the processor determines optical illumination properties for the area of destructive interference in the workpiece based on the external TFM information of the workpiece. The optical illumination properties may include, for example, an effective illumination wavelength of the object beam directed to the workpiece that would produce a highest reflectivity or detection level.

At step 254, the processor generates instructions to adjust the effective illumination wavelength of the object beam directed to the workpiece based on the optimal illumination properties. The instructions may include, for example, instructions to be transmitted to the light source, polarizer, and/or beam steering element to adjust the effective illumination wavelength of the object beam. Accordingly, step 260 may be performed to adjust the effective illumination wavelength to the optimal illumination properties for the area of destructive interference in the workpiece.

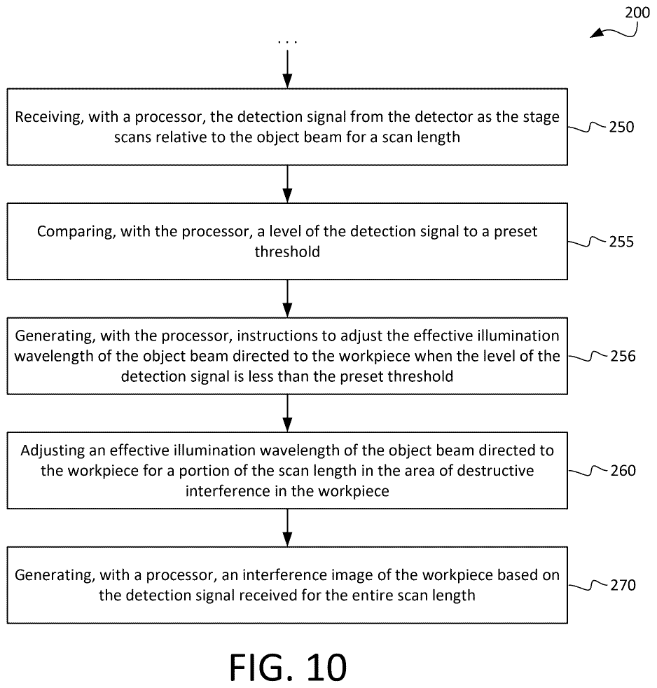

In some embodiments, before step 260, the method 200 may further comprise the following steps shown in FIG. 10.

At step 255, the processor compares a level of the detection signal to a preset threshold. The preset threshold may be a minimum reflectivity or detection value.

At step 256, the processor generates instructions to adjust the effective illumination wavelength of the object beam transmitted through the workpiece when the level of the detection signal is less than the preset threshold. Accordingly, the areas of destructive interference in the workpiece can be dynamically identified with the detection signal for active adjustment of the effective illumination wavelength in step 260. Otherwise, the effective illumination wavelength of the object beam will not be adjusted if the level of the detection signal is greater than or equal to the preset threshold to avoid unnecessary adjustments.

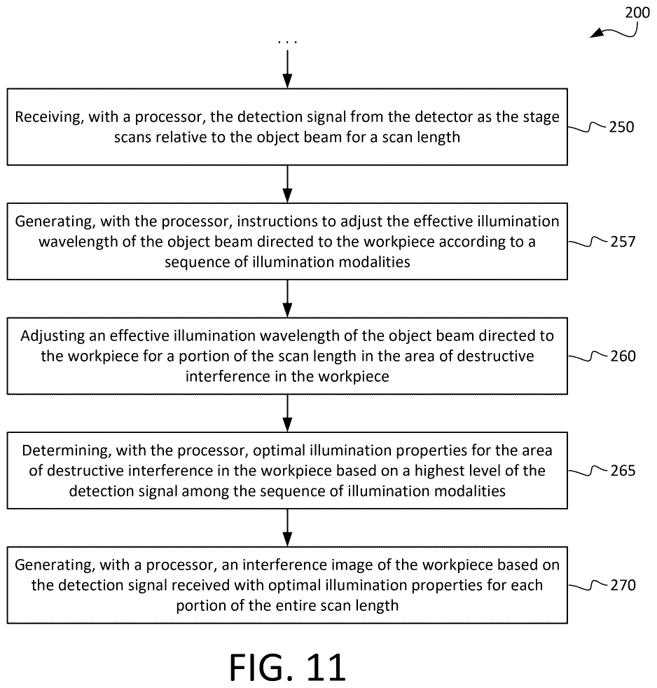

In some embodiments, before step 260, the method 200 may further comprise step 257 shown in FIG. 11. At step 257, the processor generates instructions to adjust the effective illumination wavelength of the object beam directed to the workpiece according to a sequence of illumination modalities. Accordingly, for each position of the stage within the scan length, the effective illumination wavelength may be adjusted to each of the illumination modalities in step 260. Each area of the workpiece (including any areas with destructive interference) may be therefore illuminated with an appropriate effective illumination wavelength of the object beam provided by at least one of the illumination modalities.

In some embodiments, before step 270, the method 200 may further comprise step 265. At step 265, the processor determines optimal illumination properties for the area of destructive interference in the workpiece based on a reflectivity level of the detection signal among the sequence of illumination modalities. Alternatively, the processor may use a physical or statistical model of the transparent layers and underlying materials to determine the optimal illumination properties for the area of destructive interference in the workpiece. Accordingly, the processor may generate the interference image of the workpiece based on the detection signal received with the optimal illumination properties for each portion of the scan length, ignoring parts of the detection signal generated from illumination modalities having low reflectivity levels in step 270.

With the method 200, measurements of the workpiece can be improved, due to mitigation of very low reflectivity at regions where the reflected light destructively interferes with the transparent layers of the workpiece and mitigation of very high phase sensitivity at regions where the reflected light destructively interferes within the transparent layers due to the dynamic adjustment of the effective illumination wavelength of the object beam. In some embodiments, periodic modality cycling can increase the measurement range by combining different modalities. The transmission mode can also be used to localize transparent features in the workpiece. In addition, these improvements can be applied to a wide variety of structures and do not affect the overall throughput of the metrology process.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a stage configured to support a workpiece;
an illumination subsystem comprising:
a light source configured to emit light split into a reference beam and an object beam; and
a beam steering element disposed in a path of the object beam, wherein the beam steering element is configured to direct the object beam to the workpiece;
a detection subsystem comprising:
a first beam splitter configured to combine the reference beam with the object beam transmitted through the workpiece or reflected by the workpiece into a combined beam; and
a detector configured to generate a detection signal based on the combined beam received from the first beam splitter; and
a processor in electronic communication with the illumination subsystem and the detection subsystem, wherein the processor is configured to:
receive the detection signal from the detector as the stage scans relative to the object beam for a scan length;
send instructions to the illumination subsystem to adjust an effective illumination wavelength of the object beam directed to the workpiece for a portion of the scan length in an area of destructive interference in the workpiece; and
generate an interference image of the workpiece based on the detection signal received for the entire scan length.

2. The system of claim 1, wherein the processor is further configured to:
determine amplitude and phase information of the object beam based on the interference image; and
generate a 3D map of the workpiece based on the amplitude and phase information of the object beam, an illumination wavelength of the object beam, and an angle of incidence of the object beam.

3. The system of claim 1, wherein the processor is further configured to:
receive external thin film metrology information of the workpiece; and
determine the area of destructive interference in the workpiece based on the external thin film metrology information of the workpiece.

4. The system of claim 3, wherein the processor is further configured to:
determine optimal illumination properties for the area of destructive interference in the workpiece based on the external thin film metrology information of the workpiece; and
generate instructions to adjust the effective illumination wavelength of the object beam directed to the workpiece based on the optimal illumination properties.

5. The system of claim 1, wherein the processor is further configured to:
compare a level of the detection signal to a preset threshold; and
generate instructions to adjust the effective illumination wavelength of the object beam directed to the workpiece when the level of the detection signal is less than the preset threshold.

6. The system of claim 1, wherein the processor is further configured to:
generate instructions to adjust the effective illumination wavelength of the object beam directed to the workpiece according to a sequence of illumination modalities, wherein the effective illumination wavelength of the object beam is different among each illumination modality of the sequence of illumination modalities; and
determine optimal illumination properties for the area of destructive interference in the workpiece based on a highest level of the detection signal among the sequence of illumination modalities;
wherein the interference image of the workpiece is generated based on the detection signal received with the optimal illumination properties for each portion of the scan length.

7. The system of claim 1, wherein the light source comprises a tunable light source configured to adjust a wavelength of the light emitted by the light source to adjust the effective illumination wavelength of the object beam directed to the workpiece.

8. The system of claim 1, wherein the beam steering element is further configured to adjust an angle of incidence of the object beam relative to a first side of the workpiece to adjust the effective illumination wavelength of the object beam transmitted through the workpiece.

9. The system of claim 1, wherein the illumination subsystem comprises at least two light sources, and the effective illumination wavelength of the object beam is different among the light emitted by each of the at least two light sources.

10. The system of claim 1, wherein the illumination subsystem further comprises:
a polarizer configured to adjust a polarization of the light emitted by the light source to adjust the effective illumination wavelength of the object beam directed to the workpiece.

11. The system of claim 1, wherein the illumination subsystem further comprises:
a diffraction grating disposed in the path of the object beam and configured to multiplex light from multiple angles of incidence to be directed to the workpiece;
wherein the interference image of the workpiece is generated based on the detection signal received with a highest level among the multiple angles of incidence.

12. The system of claim 1, wherein the illumination subsystem is configured to switch between at least two illumination modalities based on the instructions to adjust the effective illumination wavelength of the object beam directed to the workpiece.

13. The system of claim 12, wherein the at least two illumination modalities comprise a first illumination modality and a second illumination modality, and the processor is further configured to:
send instructions to the illumination subsystem to switch from the first illumination modality to the second illumination modality to adjust the effective illumination wavelength of the object beam directed to the workpiece for the portion of the scan length in the area of destructive interference in the workpiece; and
send instructions to the illumination subsystem to switch from the second illumination modality to the first illumination modality to adjust the effective illumination wavelength of the object beam directed to the workpiece for a portion of the scan length outside of the area of destructive interference in the workpiece.

14. A method comprising:
emitting light from a light source, wherein the light is split into a reference beam and an object beam;
directing, with a beam steering element, the object beam to a workpiece supported by a stage;
combining, with a beam splitter, the reference beam and the object beam transmitted through the workpiece or reflected by the workpiece into a combined beam;
generating, with a detector, a detection signal based on the combined beam received from the beam splitter;
receiving, with a processor, the detection signal from the detector as the stage scans relative to the object beam for a scan length;
adjusting an effective illumination wavelength of the object beam directed to the workpiece for a portion of the scan length in an area of destructive interference in the workpiece; and
generating, with the processor, an interference image of the workpiece based on the detection signal received for the entire scan length.

15. The method of claim 14, further comprising:
determining, with the processor, amplitude and phase information of the object beam based on the interference image; and
generating, with the processor, a 3D map of the workpiece based on the amplitude and phase information of the object beam, an illumination wavelength of the object beam, and an angle of incidence of the object beam.

16. The method of claim 14, wherein before adjusting the effective illumination wavelength of the object beam directed to the workpiece, the method further comprises:
receiving, with the processor, external thin film metrology information of the workpiece; and
determining, with the processor, the area of destructive interference in the workpiece based on the external thin film metrology information of the workpiece.

17. The method of claim 16, wherein before adjusting the effective illumination wavelength of the object beam directed to the workpiece, the method further comprises:
determining, with the processor, optimal illumination properties for the area of destructive interference in the workpiece based on the external thin film metrology information of the workpiece; and
generating, with the processor, instructions to adjust the effective illumination wavelength of the object beam directed to the workpiece based on the optimal illumination properties.

18. The method of claim 14, further comprising:
comparing, with the processor, a level of the detection signal to a preset threshold; and
generating, with the processor, instructions to adjust the effective illumination wavelength of the object beam directed to the workpiece when the level of the detection signal is less than the preset threshold.

19. The method of claim 14, further comprising:
generating, with the processor, instructions to adjust the effective illumination wavelength of the object beam directed to the workpiece according to a sequence of illumination modalities,
wherein the effective illumination wavelength of the object beam is different among each illumination modality of the sequence of illumination modalities; and
determining optimal illumination properties for the area of destructive interference in the workpiece based on a highest level of the detection signal among the sequence of illumination modalities;
wherein the interference image of the workpiece is generated based on the detection signal received with the optimal illumination properties for each portion of the scan length.

20. The method of claim 14, wherein adjusting the effective illumination wavelength of the object beam directed to the workpiece comprises:
switching from a first illumination modality to a second illumination modality to adjust the effective illumination wavelength of the object beam directed to the workpiece for the portion of the scan length in the area of destructive interference in the workpiece; and
switching from the second illumination modality to the first illumination modality to adjust the effective illumination wavelength of the object beam directed to the workpiece for a portion of the scan length outside of the area of destructive interference in the workpiece.
